(19) United States
(12) Patent Application Publication
(10) Pub. No.: US 2009/0139848 A1
(43) Pub. Date: Jun. 4, 2009

(54) WINDOW

(75) Inventor: Konrad Kaiser, Geseke (DE)

Correspondence Address: GAUTHIER & CONNORS, LLP, 225 FRANKLIN STREET, SUITE 2300, BOSTON, MA, 02110, US

(73) Assignee: SCHUCO International KG, Bielefeld (DE)

(21) Appl. No.: 12/234,792

(22) Filed: Sep. 22, 2008

Related U.S. Application Data
(63) Continuation of application No. PCT/EP2007/052537, filed on Mar. 16, 2007.

(30) Foreign Application Priority Data
Mar. 20, 2006 (DE) 10 2006 013 028.6

(51) Int. Cl. H01H 3/00

(52) U.S. Cl. 200/52 R

(57) ABSTRACT

A window, in particular a turn-and-tilt window, comprises a window handle (2) that has a handle (4) for the manual movement, in particular rotation, of a window casement (3) of the window (1), wherein switching elements (19, 23, 24) are provided on the window (1) and/or window handle (2). According to the invention, the switching elements (19, 23, 24) are coupled to a control for actuating at least one peripheral device (6-17) arranged at a distance from the window (1). A central switching system for different peripheral devices (6-17) can thus be embodied on the window (1).

### PRIORITY INFORMATION

This application claims the benefit of International Patent Application Serial No. PCT/EP2007/052537 filed on Mar. 16, 2007 and claims priority to German Application Serial No. 10 2006 013 028.6, filed on Mar. 20, 2006.

### BACKGROUND OF THE INVENTION

1. Field of the Invention

The present invention relates to a window, in particular a turn-and-tilt window, with a window handle that has a handle for the manual movement, in particular rotation, of a window casement of the window, wherein switching elements are provided on the window and/or window handle.

2. Brief Description of the Art

DE 10 2004 018 063 shows a window handle for the actuation of an automatic window, wherein the window handle lever switches the locking and the opening drive via different switch positions. The window can thus be moved via drive means instead of via mechanical means. The switch elements can thereby be controlled via electric lines or wirelessly in order to trigger a corresponding locking or movement of a window casement.

DE 10 2004 060 202 shows a window handle in which switching keys are provided on the handle, by means of which switching keys the opening of the window, in particular tilting, is controlled. To this end a rocker is coupled with a corresponding switching device so that corresponding locking devices and drives on the window can be moved.

Furthermore, often further peripheral devices are often arranged on the window or on a façade, for example for shading, ventilating and for other functions that are activated mechanically or via switches. Since the peripheral devices usually come from different manufacturers, each has its own control or its own actuating mechanism.

### SUMMARY OF THE INVENTION

The object of the present invention is therefore to create a window, in particular a turn-and-tilt window, which takes over other functions in addition to the function of a window.

This object is attained with a window with the features of claim 1.

According to the invention, switching elements are provided on the window and/or window handle, which switching elements are coupled to a control for actuating at least one peripheral device arranged at a distance from the window. The window with the switching elements thus forms a central control system to select peripheral devices that are then actuated, in particular moved. Since a window is usually freely accessible for ventilation, it is extremely practical if switching elements for operating peripheral devices are also provided on the window in addition, since then a complex cabling adjacent to the window can be omitted.

According to a preferred embodiment of the invention, the switching elements have a selector button for selecting the peripheral device and at least one switch for controlling the peripheral device. The control thus remains easy to operate, since initially the peripheral device to be controlled is selected, which can be signaled by an optical and/or acoustic signal, wherein subsequently a corresponding actuation then takes place through the control switch.

As a peripheral device, for example, a driven shading element can be provided on the window, wherein the shading element can be arranged in the interior as well as on the outside. Furthermore, as a peripheral device, a moveable ventilation element, for example, a driven ventilation damper can be actuated above the window or at another location. Moreover, it is possible for the peripheral device to be an alarm system and/or a switchable lamp that can be switched on or off via the switching elements. As a peripheral device in addition a heating device and/or an air-conditioning system can be provided, so that the air-conditioning of the room is carried out via the control on the window.

Furthermore, the window itself can also be moved by the switching elements, for example, into a tilt position or another ventilation position.

Preferably, the control is provided with at least one sensor for the automatic actuation of a peripheral device. For example, a wind gauge can be provided that automatically raises a shading system attached outside on the window when wind forces are measured that are too high. Furthermore, the sunlight exposure can be detected via a light sensor so that a shading system can also be automatically moved into the shading position. Furthermore, a CO₂ sensor can also be used for the control of the room atmosphere.

According to a further development of the invention, the control has a clock, wherein at least one peripheral device can be controlled per time setting. For example, in cities with a high risk of smog, a ventilation of the building can be set automatically for the early morning hours, when the air is best. Moreover, with a corresponding time setting the control can also perform a wakeup function, for example, when a shading system is raised in the morning, because daylight is shining into the building. Furthermore, the control can be coupled to a loudspeaker for emitting acoustic signals.

According to a preferred embodiment of the invention, the switching elements are arranged on the handle and/or on an escutcheon. The user is accustomed to operating a window by the handle, so it is useful for easy operation to also provide a central switching system for the peripheral devices there. The control of the peripheral devices can thereby be carried out wirelessly via radio, infrared or, if needed, also via cabling.

According to a further embodiment of the invention, the switching elements are held on the window and/or on the window handle in a removable manner, so that the switching elements can be held freely in the manner of a remote control. The remote control can be embodied as a component part of the window handle so that the user has the option of detaching the switching elements from the window handle and then to select the peripheral devices as a remote control.

The control can preferably be programmed for coupling with peripheral devices so that the window can be used for existing peripheral devices. A corresponding window can then also be easily retrofitted, wherein the peripheral devices for this purpose are given a corresponding transmitter.

### BRIEF DESCRIPTION OF THE DRAWINGS

The invention is explained in more detail below based on several exemplary embodiments with reference to the attached drawings. They show:

FIG. 1 A diagrammatic view of a turn-and-tilt window;

FIG. 2 A diagrammatic view of a façade with a turn-and-tilt window;

FIG. 3 A view of a façade element with ventilation elements;

FIG. 4 A side view of the façade element of FIG. 3;

FIG. 5 A perspective view of a window handle with switching elements on the escutcheon;

FIG. 6 A perspective view of a window handle with switching elements and

FIG. 7 A perspective view of a window handle with switching elements.

### DETAILED DESCRIPTION OF THE INVENTION

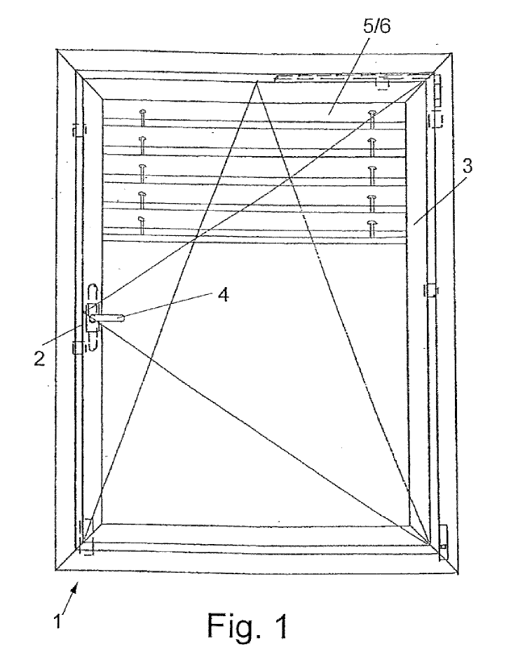

FIG. 1 shows a rotatable and tiltable window 1, which has a window handle 2, which is mounted on a window casement 3. The window handle 2 can thereby have purely mechanically a tilt gear arranged in the rose housing or a tilt gear arranged in a hidden manner in the rabbet between the frame and the casement frame and carry out the locking of the window casement 3 in turn position and tilt position mechanically by actuating a hand lever 4. Alternatively, the hand lever 4 is only supported on the frame 3 and is used as a switch to actuate the automatic locking of the window casement 3, as is shown, for example in document DE 10 2004 060 202.

An exterior blind 5 and/or a roller shutter 6, which is motor-driven, is provided on the outside of the window 1. Furthermore, it is also possible to provide corresponding blinds or other shading elements lying on the inside of the window casement 3, which shading elements can likewise be driven. These shading elements are respectively formed by a peripheral device, which can be actuated according to the invention via switching elements on the window handle 2 and/or on the window 1. For this purpose the switching elements are coupled to the respective peripheral device via a radio control for a wireless transmission of the switching pulses or connected by lines.

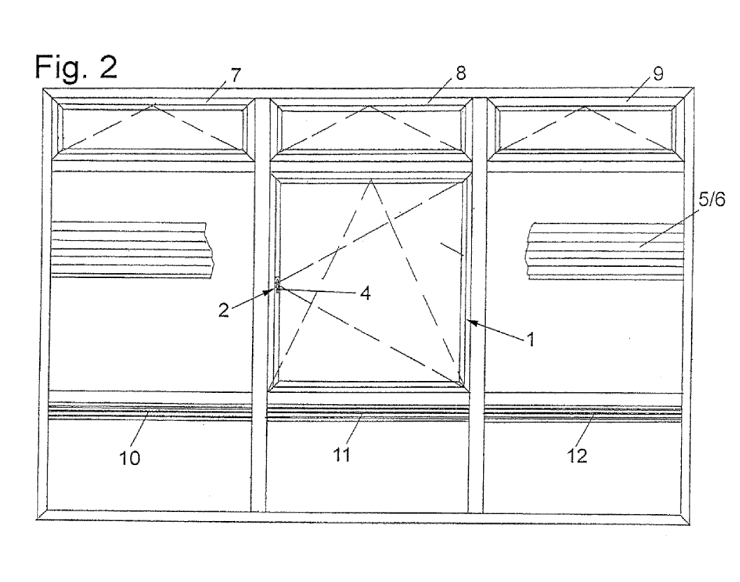

FIG. 2 shows a façade element in which a window 1 is provided with a window casement 3 and a window handle 2. Transoms 7, 8 and 9 are arranged above the window 1, which transoms can be brought into an open position. Fittings corresponding to drives are provided for this purpose. Furthermore, exterior blinds 5 or roller shutters 6 are provided on adjacent panels, and fans 10, 11 and 12 below the window 1 are shown diagrammatically. These fans 10, 11, 12 can have ventilation dampers, ventilators and other driven components, which likewise are peripheral devices as defined by the present invention. All of the peripheral devices can be switched on and off, or brought in to the desired position via the window handle 2 and corresponding switching elements.

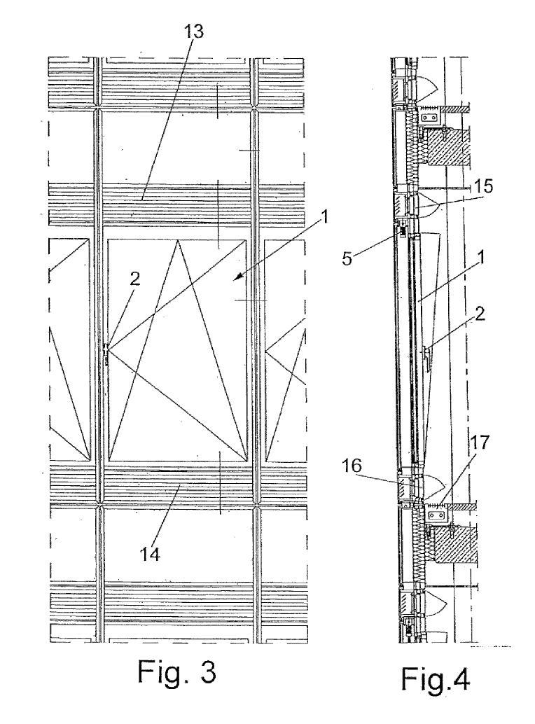

FIG. 3 shows another façade element with a window 1, on which a window handle 2 with switching elements for controlling peripheral devices is provided. Above the window 1 embodied as a turn-and-tilt window, ventilation blinds 13 are located and ventilation blinds 14 arranged below the window, which hide a vent or a ventilation damper located on the inside, as is discernible in FIG. 4. The ventilation dampers 15 and 16 are motor-driven and can be controlled via corresponding switching elements on the window handle 2.

An exterior blind 5 is arranged adjacent to the window 1, which exterior blind can be lowered and raised in a motor-driven manner.

A convector as a heater and/or a ventilation air-conditioning element 17 is arranged in the floor area adjacent to the window 1, which convector forms a peripheral device and is motor-driven. The interior room atmosphere can be controlled by a corresponding switch via the switching elements on the window 1 or window handle 2.

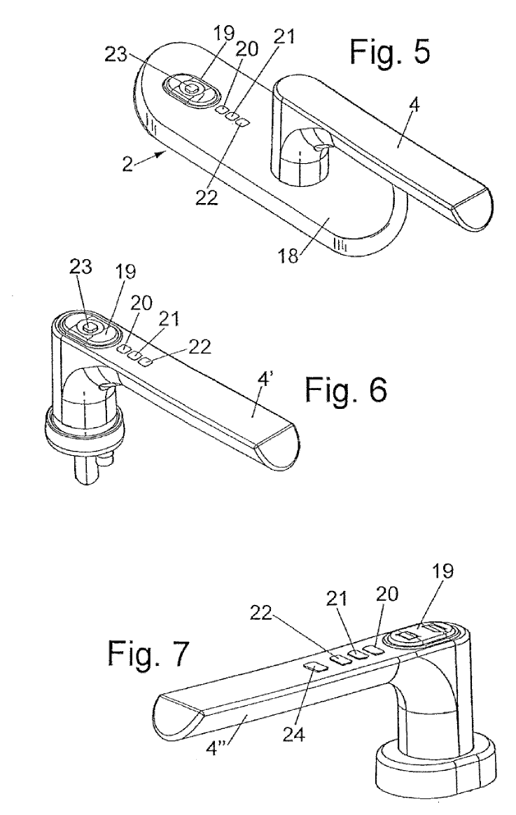

FIG. 5 shows a window handle 2 that has a hand lever 4 and an escutcheon 18 or a rose. A rocker switch 19 is provided on the escutcheon 18, which rocker switch renders possible an actuation for the function of the peripheral devices as well as of the window 1, for example, to be moved up or down, the roller shutter or the exterior blind up or down, any lamps can be switched on or off.

Next to the rocker switch 19 are located mini-displays 20, 21 and 22, which can be labeled at the side, illuminated by light-emitting diodes, wherein respectively one mini-display 20, 21 or 22 can be selected via a selector button 23, which mini-display is respectively assigned to a peripheral device. Thus, for example, the mini-display 20 can stand for tilting open the window 1, while the mini-display 21 is assigned to a shading element 5, 6, while the mini-display 22 is assigned to a transom 7, 8, 9, or to a ventilation damper. When the corresponding peripheral device is to be actuated with the rocker switch 19, the selector button 23 is pressed, wherein a different peripheral device, which is displayed via the mini-displays 20, 21, 22, is selected by each press. A mini-display 20, 21 and 22 respectively lights up and thus signals to the user that the corresponding peripheral device can now be actuated via the selector button. The assignment to the peripheral device can be indicated by a written label, a corresponding pictogram or other visual elements. Moreover, it is also possible to provide a small loudspeaker on the window 1, which loudspeaker gives the user an acoustic signal showing which peripheral device can be selected upon actuation of the selector button 23. Thus the control to the respective peripheral device can be navigated via the selector button 23 with optical and/or acoustic signals. The rocker switch 19 then takes over the respective switching processes of the selected peripheral device.

With the embodiment shown in FIG. 6, a control is provided on a hand lever 4′ of the window handle 2, which control as a switching element has a rocker switch 19, and selector button 23 and adjacent hereto mini-displays 20, 21 and 22. The function of the selector button 23, the rocker switch 19 and the mini-displays 20, 21 and 22 is as in the previous exemplary embodiment. The arrangement of the switching elements 19 and 23 on the hand lever 4′ simplifies the operation of window 1, since the user is accustomed anyway to grasp the hand lever 4′ and then can also select corresponding peripheral devices at the same time. Furthermore, a manual actuation of the window 1 can also be carried out via the hand lever 4′.

FIG. 7 shows a modified embodiment of a hand lever 4′ in which a rocker switch 19 is provided, which rocker switch does not have a selector button in the center, in order to avoid an operating error. Instead, a selector button 24 is provided at a distance from the switching element 19, which selector button can be actuated in order to control the individual peripheral devices, which again is signaled by the mini-displays 20, 21 and 22. The respectively illuminated mini-display 20, 21 or 22 can then be selected with the corresponding peripheral device via the rocker switch 19.

In the embodiments shown, the switching elements 19 and 23, 24 are respectively arranged in a fixed manner on an escutcheon 18 or on a hand lever 4, 4′ or 4″. It is also possible to embody the hand lever 4′ or 4″ in a multiple-part manner, wherein the area with the switching elements 19, 23 and 24 as well as the mini-displays 20, 21 and 22 can be removed so that the control together with the switching elements 19, 23 and 24 acts as a remote control. Otherwise, the hand lever 4′ and 4″ can retain its mechanical function.

The control can thereby have batteries and a printed circuit board, which is arranged inside the hand lever 4′ or 4″.

The control can thereby either select the respective peripheral devices via a cabling or render possible a cableless remote transmission of signals via radio or infrared. An antenna can be arranged for this purpose inside the hand lever 4′ or 4″.

What we now claim is:

1. A window, in particular a turn-and-tilt window, with a window handle that has a handle for the manual movement, in particular rotation, of a window casement of the window, wherein switching elements are provided on the window and/or window handle, such that the switching elements are coupled to a control for actuating at least one peripheral device arranged at a distance from the window.

2. The window according to claim 1, wherein the switching elements have a selector button for selecting the peripheral device and at least one switch for controlling the peripheral device.

3. The window according to claim 1, wherein a driven shading element is provided as a peripheral device.

4. The window according to claim 1, wherein a moveable ventilation element is provided as a peripheral device.

5. The window according to claim 1, wherein at least one switchable lamp is provided as a peripheral device.

6. The window according to claim 1, wherein the window is driven and the window is moveable via the switching elements.

7. The window according to claim 1, wherein the control is to be seen with at least one sensor for the automatic actuation of a peripheral device.

8. The window according to claim 1, wherein the control has a clock and at least one peripheral device can be controlled per time setting.

9. The window according to claim 1, wherein the control is coupled to a loudspeaker for emitting acoustic signals.

10. The window according to claim 1, wherein the switching elements are arranged on the handle and/or on an escutcheon.

11. The window according to claim 1, wherein the control selects the peripheral devices wirelessly via radio.

12. The window according to claim 1, wherein the switching elements are held on the window and/or window handle in a removable manner.

13. The window according to claim 1, wherein a switchable heater is provided as a peripheral device.

14. The window according to claim 1, wherein a switchable air-conditioning system is provided as a peripheral device.

15. The window according to claim 1, wherein the control is programmable for coupling with peripheral devices.
